(19) United States
(12) Patent Application Publication
(10) Pub. No.: US 2024/0221063 A1
(43) Pub. Date: Jul. 4, 2024

(54) XR MALL GENERATION DEVICE, CONTROL METHOD FOR XR MALL GENERATION DEVICE, AND XR MALL GENERATION PROGRAM

(71) Applicant: SOFTBANK CORP., Tokyo (JP)

(72) Inventors: Naohiro AKIYAMA, Tokyo (JP); Yoshihiro ENDO, Tokyo (JP); Yuta MIZUNO, Tokyo (JP); Daisuke TAKANO, Tokyo (JP); Junichiro MAMIYA, Tokyo (JP)

(73) Assignee: SOFTBANK CORP., Tokyo (JP)

(21) Appl. No.: 18/563,261

(22) PCT Filed: Mar. 3, 2022
(86) PCT No.: PCT/JP2022/009038

§ 371 Date: Nov. 21, 2023

(30) Foreign Application Priority Data
May 26, 2021 (JP) 2021-088665

(51) Int. Cl. G06Q 30/0601; G06Q 30/0251

(52) U.S. Cl. CPC G06Q 30/0643; G06Q 30/0255; G06Q 30/0271

(57) ABSTRACT

An extended reality (XR) mall generating device includes: an XR mall generating section that generates an XR mall including a plurality of XR stores in each of which a user is capable of experiencing shopping with use of an XR technology; and an XR mall providing section that provides the XR mall to the user.

### CROSS-REFERENCE TO RELATED APPLICATIONS

This application is a U.S. national stage application under 35 U.S.C. § 371 of International Application No. PCT/JP2022/009038, filed Mar. 3, 2022, which claims the priority of Japanese Application No. 2021-088665, filed May 26, 2021. The entire contents of each priority application is incorporated herein by reference.

### FIELD OF THE DISCLOSURE

The present invention relates to an XR mall generating device, a method for controlling an XR mall generating device, and an XR mall generating program.

### BACKGROUND OF THE DISCLOSURE

In recent years, various types of extended reality (XR) technology have been developed.

The XR technology is also referred to as xR or cross reality, and is a generic term for virtual reality (VR), augmented reality (AR), mixed reality (MR), and substitutional reality (SR).

A VR technology is a technology of making it possible to experience a virtual space that differs from a real space and that is referred to as a virtual reality. An AR technology is a technology of superimposing information on a real space. An MR technology is a technology of fusing a real space and a virtual space together such that the real space and the virtual space affect each other. An SR technology is a technology of mixing a video of a current real space (real video) and a video of a different space such as a past space and a fictitious space and thus creating an illusion of the presence, in the current real space, of a person, an event, and the like that do not actually exist.

In this manner, the XR technology is a technology that makes it possible to provide a realistic experience to a user by carrying out, with respect to at least a part of a real space, substitution, superimposition, fusion, mixture, or the like with a different space such as a virtual space. It is expected that industries in which the XR technology is used will develop in the future.

### [Patent Literature 1]

Japanese Patent Application Publication Tokukai No. 2005-316586

### SUMMARY OF THE DISCLOSURE

However, a technology of providing a realistic shopping experience to a user with use of the XR technology has not been sufficiently developed. Patent Document 1 discloses that a townscape is displayed on a display section of a personal computer or a terminal and a self-avatar of a user does shopping or the like in the townscape. However, this technology is not a technology in which the XR technology is used, and thus cannot be said to be a technology of providing a realistic shopping experience to a user.

### Solution to Problem

An XR mall generating device in accordance with an aspect of the present invention is an XR mall generating device including: an XR mall generating section that generates an XR mall including a plurality of XR stores in each of which a user is capable of experiencing shopping with use of an XR technology; and an XR mall providing section that provides the XR mall to the user.

A method for controlling an XR mall generating device in accordance with an aspect of the present invention is a method for controlling an XR mall generating device, including: an XR mall generating step in which the XR mall generating device generates an XR mall including a plurality of XR stores in each of which a user is capable of experiencing shopping with use of an XR technology; and an XR mall providing step in which the XR mall generating device provides the XR mall to the user.

The XR mall generating device in accordance with each aspect of the present invention may be realized by a computer. In this case, the present invention also encompasses, in its scope, (i) an XR mall generating program for realizing the XR mall generating device by the computer by causing the computer to operate as each section (software element) included in the XR mall generating device and (ii) a computer-readable recording medium in which the XR mall generating program is recorded.

### BRIEF DESCRIPTION OF THE FIGURES

FIG. 1 is a view illustrating an example of a configuration of an XR mall generation system in accordance with Embodiment 1.

FIG. 2 is a view illustrating an example of a structure of information concerning a user.

FIG. 3 is a view illustrating an example of a structure of information concerning XR stores.

FIG. 4 is a view illustrating an example of a controlling process carried out in the XR mall generation system in accordance with Embodiment 1.

FIG. 5 is a view illustrating an example of a configuration of an XR mall generation system in accordance with Embodiment 2.

FIG. 6 is a block diagram illustrating an example of a configuration of a computer that can be used as each of a customer-side terminal, a store-side terminal, and an XR mall generating device in accordance with each embodiment.

### DETAILED DESCRIPTION OF THE DISCLOSURE

### Embodiment 1

### XR Mall Generation System 1

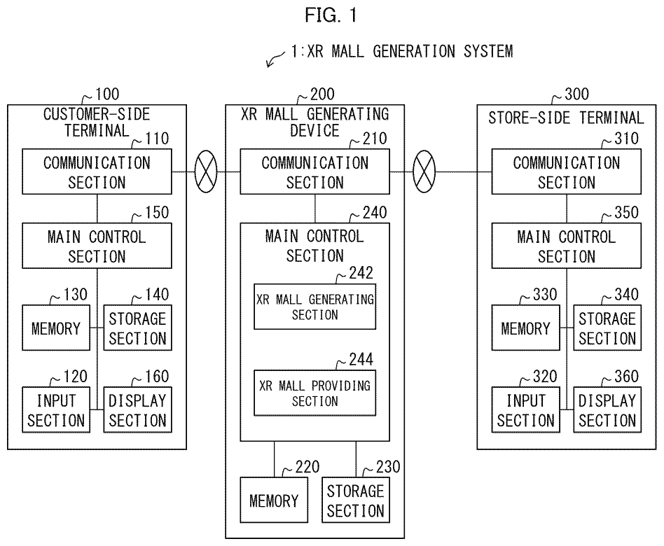

FIG. 1 is a view illustrating an example of a configuration of an XR mall generation system 1 in accordance with Embodiment 1 of the present invention. The XR mall generation system 1 may include a customer-side terminal 100, an XR mall generating device 200, and a store-side terminal 300. Note that the number of customer-side terminals 100 included in the XR mall generation system 1 and the number of store-side terminals 300 included in the XR mall generation system 1 are not limited in particular, and may be each one or more.

The XR mall generation system 1 may be a system that generates an XR mall including a plurality of XR stores and provides the XR mall to a user. An XR store indicates a store in which the user is capable of experiencing shopping with use of an XR technology. The XR mall indicates a shopping mall in which the user is capable of experiencing shopping with use of the XR technology. The XR technology indicates a technology of providing a realistic experience to the user by carrying out, with respect to at least a part of a real space, substitution, superimposition, fusion, mixture, or the like with a different space such as a virtual space. Generating the XR mall indicates generating data necessary for the user to experience the XR mall (information concerning the XR mall). Providing the XR mall indicates providing, to an apparatus used by the user, the information concerning the XR mall.

In the XR mall generation system 1, information concerning XR stores may be provided from the store-side terminal 300 to the XR mall generating device 200, the XR mall may be generated in the XR mall generating device 200 on the basis of the information concerning the XR stores, and the XR mall may be provided to the customer-side terminal 100. This makes it possible for the user who uses the customer-side terminal 100 to experience realistic shopping with use of the XR technology.

The customer-side terminal 100 is a terminal used by the user who experiences the XR mall. By using the customer-side terminal 100, the user can experience shopping with use of the XR technology. The customer-side terminal 100 is not limited in particular, and may be, for example, a display device such as a head-mounted display, a smartphone, a tablet terminal, smart glasses, or a smart contact lens.

Note that, in this specification, XR may include at least one of virtual reality (VR), augmented reality (AR), mixed reality (MR), and substitutional reality (SR) or may include two or more or all of these technologies.

For example, a VR technology is a technology of making it possible to experience a virtual space that differs from a real space and that is referred to as a virtual reality. The customer-side terminal 100 is not limited in particular, and may be, for example, a head-mounted display or the like.

An AR technology is a technology of superimposing information on a real space. The customer-side terminal 100 is not limited in particular, and may be, for example, a smartphone, a tablet terminal, smart glasses, a smart contact lens, or the like.

An MR technology is a technology of fusing a real space and a virtual space together such that the real space and the virtual space affect each other. The customer-side terminal 100 is not limited in particular, and may be, for example, a smartphone, a tablet terminal, smart glasses, a smart contact lens, or the like.

An SR technology may be a technology of mixing a video of a current real space (real video) and a video of a different space such as a past space and a fictitious space and thus creating an illusion of the presence, in the current real space, of a person, an event, and the like that do not actually exist. The customer-side terminal 100 is not limited in particular, and may be, for example, a head-mounted display or the like.

For example, an SR technology may be a technology of weaving a current real video and a past video that was shot in the same place or substituting the past video for the current real video or vice versa and displaying an obtained video on a display section of a head-mounted display or the like. The SR technology may be a technology of mixing a video of the legs of a user in a current real space and a video of the legs of another person which video was shot in a very similar place that the user does not notify and displaying an obtained video on a display section of a head-mounted display or the like. The SR technology makes it impossible for a user to distinguish between a current real video and a past video, and consequently makes it possible for the user to come from and go to a current real space and a different space.

The store-side terminal 300 may be a terminal that provides, to the XR mall generating device 200, the information concerning the XR stores which correspond to the store-side terminal 300. The XR mall generated by the XR mall generating device 200 may include the plurality of XR stores that have been selected from an XR store group corresponding to each store-side terminal 300. In other words, the information concerning the XR stores which information is provided by each store-side terminal 300 may be information concerning candidates for the XR stores included in the XR mall. The store-side terminal 300 is not limited in particular, and may be a computer device such as a personal computer, a smartphone, or a tablet terminal.

The XR mall generating device 200 generates the XR mall, and provides the XR mall to the user. The XR mall generating device 200 is not limited in particular, and may be a computer device such as a server. Details of each device are described below.

### Customer-Side Terminal 100

The customer-side terminal 100 may include a communication section 110, an input section 120, a memory 130, a storage section 140, a main control section 150, and a display section 160.

The communication section 110 may communicate with a communication section 210 of the XR mall generating device 200 via a network.

The input section 120 may be, for example, an input device that accepts an input from the user, such as a controller, a touch panel, a mouse, or a keyboard, or may be a detecting device that detects a motion of the user, such as a motion sensor or a motion camera. The input section 120 may be a combination of these devices.

In the memory 130, various programs that are executed by the main control section 150 and various pieces of data that are referred to by the various programs may be temporarily stored.

In the storage section 140, various pieces of information that are, for example, read, written, and referred to by the main control section 150 may be stored.

The main control section 150 may control the communication section 110, the input section 120, the memory 130, the storage section 140, and the display section 160. For example, the main control section 150 may control the display section 160 to display the XR mall with reference to the information concerning the XR mall which information has been received by the communication section 110.

The display section 160 may display the XR mall. The display section 160 may be, for example, a display such as a head-mounted display, a smartphone, or a tablet terminal or may be a projecting part such as smart glasses or a smart contact lens.

Store-side terminal 300 The store-side terminal 300 may include a communication section 310, an input section 320, a memory 330, a storage section 340, a main control section 350, and a display section 360.

The communication section 310 may communicate with the communication section 210 of the XR mall generating device 200 via a network.

The input section 320 may be, for example, an input device that accepts an input from the user, such as a touch panel, a mouse, or a keyboard.

In the memory 330, various programs that are executed by the main control section 350 and various pieces of data that are referred to by the various programs may be temporarily stored.

In the storage section 340, various pieces of information that are, for example, read, written, and referred to by the main control section 350 may be stored.

The main control section 350 may control the communication section 310, the input section 320, the memory 330, the storage section 340, and the display section 360. For example, the main control section 350 may provide, to the XR mall generating device 200 via the communication section 110, the information concerning the stores which information has been inputted into the input section 320.

The display section 360 may be, for example, a display.

### XR Mall Generating Device 200

The XR mall generating device 200 may include the communication section 210, a memory 220, a storage section 230, and a main control section 240.

The communication section 210 may communicate with each of the communication section 110 of the customer-side terminal 100 and the communication section 110 of the store-side terminal 300 via the network.

In the memory 220, various programs that are executed by the main control section 240, such as an XR mall generating program, and various pieces of data that are referred to by the various programs may be temporarily stored.

In the storage section 230, various pieces of information that are, for example, read, written, and referred to by the main control section 240 may be stored.

The main control section 240 may control the communication section 210, the memory 220, and the storage section 230. For example, the main control section 240 may generate the XR mall with reference to various pieces of information that have been received by the communication section 210, and cause the XR mall to be provided to the user via the communication section 210 of the XR mall generating device 200 and the communication section 110 of the customer-side terminal 100. The main control section 240 may include an XR mall generating section 242 and an XR mall providing section 244.

### XR Mall Generating Section 242

The XR mall generating section 242 may generate the XR mall. In other words, the XR mall generating section 242 may generate the information concerning the XR mall. The information concerning the XR mall may include data for experiencing the XR mall with use of the XR technology, e.g., 3D modeling data of the stores, commodities, salesclerks, and the like. By the XR mall generating section 242 generating the XR mall that can be experienced with use of the XR technology and then providing the XR mall to the user, it is possible for the user to, unlike an EC site, view or touch a realistic XR commodity that is constituted based on, for example, 3D modeling data, instead of viewing a commodity with reference to a picture, characters, and the like.

In this manner, by providing, to the user himself/herself, XR commodities, the XR stores, and the XR mall each of which has a realistic appearance, it is possible for the user to experience realistic shopping as an experience of the user himself/herself, like experiencing shopping in a physical store. This makes it possible to provide a realistic and new shopping experience to the user.

Moreover, it is possible for the user to purchase a commodity in an XR store corresponding to a desired physical store without going to the physical store. Therefore, it is possible to reduce a time for the user to take to move to the store.

The XR mall generating section 242 may conduct one or both of the following operations (1) and (2):
(1) the XR mall generating section 242 may generate the XR mall for each user with reference to information concerning the user; and
(2) the XR mall generating section 242 may generate the XR mall with reference to the information concerning the XR stores in the XR store group that are the candidates for the XR stores included in the XR mall.

In a case where the XR mall generating section 242 conducts the operation (1), it is possible to generate the XR mall in which personalized information is referred to, such as the XR mall that includes the XR stores each having an XR commodity which the user wants, unlike an EC site that, although having much information, lacks information which the user desires. As a result, it is possible to provide, to the user, a personalized and satisfactory XR mall of his/her own.

In a case where the XR mall generating section 242 conducts the operation (2), it is possible for the XR mall generating section 242 to generate the XR mall that includes the XR stores, that is more realistic, and that uses merits of a mall-type EC site and an in-house EC site and overcomes demerits of a conventional EC site.

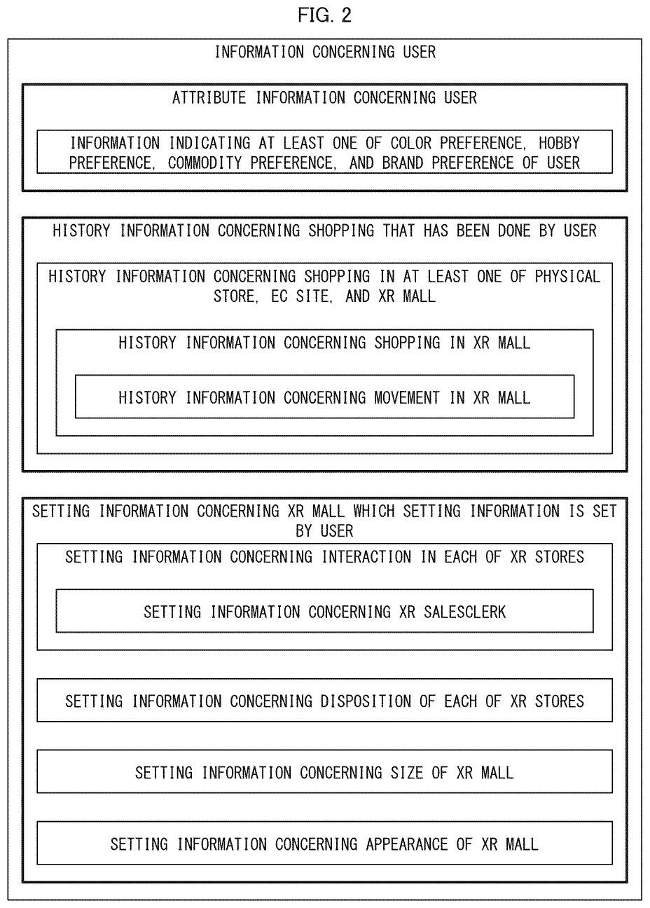

Below described are various pieces of information used in the present embodiment. First, the information concerning the user is described with reference to FIG. 2. FIG. 2 is a view illustrating an example of a structure of the information concerning the user.

### Information Concerning User

As illustrated in FIG. 2, the information concerning the user may include at least one of (i) attribute information concerning the user, (ii) history information concerning shopping that has been done by the user, and (iii) setting information concerning the XR mall which setting information is set by the user (customer-side setting information). Since the information concerning the user includes at least one of these pieces of information, it is possible to provide, to the user, the XR mall that is more personalized.

### Attribute Information Concerning User

The attribute information concerning the user may include information indicating at least one of a color preference, a hobby preference, a commodity preference, and a brand preference of the user. With reference to the attribute information concerning the user, which attribute information includes at least one of these pieces of information, the XR mall generating section 242 may determine, from the XR store group that are the candidates for the XR stores included in the XR mall, the XR stores in each of which a commodity that is close to a preference of the user is displayed, and then generate the XR mall including the XR stores. This makes it possible to provide, to the user, the XR mall in which the preference of the user is reflected, which includes the XR stores that are desired by the user, and which is further personalized.

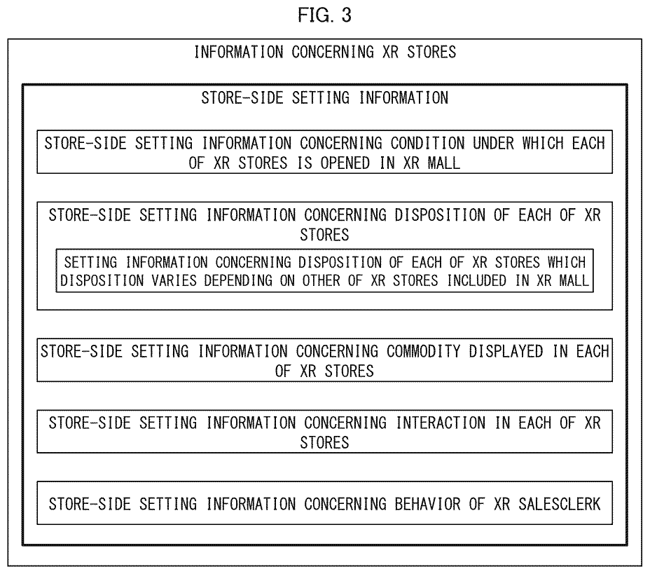

Note that, in an example illustrated in FIG. 3, the XR mall generating section 242 determines the XR stores included in the XR mall, with reference to the attribute information concerning the user. However, in the present embodiment, the setting information concerning the XR mall which setting information is set by the user (described later) may further include setting information concerning the XR stores included in the XR mall, and with reference to the setting information concerning the XR stores which setting information has been inputted by the user, the XR mall generating section 242 may generate the XR mall. This makes it possible for the XR mall generating section 242 to generate the XR mall including the XR stores that the user desires more directly.

History Information Concerning Shipping that has been Done by User

The history information concerning the shopping that has been done by the user may include history information concerning the shopping in at least one of a physical store, an EC site, and the XR mall.

In a case where the history information concerning the shopping that has been done by the user includes the history information concerning the shopping in at least one of the physical store, the EC site, and the XR mall, it is possible to provide, to the user, the XR mall that is more personalized.

### History Information Concerning Shopping in at Least One of Physical Store, EC Site, and XR Mall

The history information concerning the shopping in at least one of the physical store, the EC site, and the XR mall may include at least one of, for example, purchase history information, browsing history information (e.g., a wish-list), behavior history information, line-of-sight history information, and search history information.

In a case where the history information concerning the shopping in at least one of the physical store, the EC site, and the XR mall includes at least one of these pieces of history information, it is possible to provide, to the user, the XR mall that is particularly personalized.

The history information concerning the shopping in the XR mall may include history information concerning movement in the XR mall. In a case where the history information concerning the shopping in the XR mall includes the history information concerning the movement in the XR mall, it is possible to provide, to the user, the XR mall that is particularly personalized.

Setting Information Concerning XR which Setting Information is Set by the User

The setting information concerning the XR mall which setting information is set by the user may include at least one of (i) setting information concerning an interaction in each of the XR stores, (ii) setting information concerning disposition of each of the XR stores, (iii) setting information concerning a size of the XR mall, and (iv) setting information concerning an appearance of the XR mall.

In a case where the setting information concerning the XR mall which setting information is set by the user includes at least one of these pieces of setting information, it is possible to provide, to the user, the XR mall in which a preference of the user is reflected and which is more personalized.

### Setting Information Concerning Interaction in Each of XR Stores

In a case where the setting information concerning the XR mall which setting information is set by the user includes the setting information concerning the interaction in each of the XR stores, it is possible for the XR mall generating section 242 to generate, for example, the XR mall including the XR stores in each of which information, an advertisement, or the like concerning a commodity is superimposed on a VR commodity with use of the AR technology. As a result, it is possible for the XR mall providing section 244 to provide, to the user in each of the XR stores, the interaction such as attendance of higher quality.

The setting information concerning the interaction in each of the XR stores may be information set with regard to the presence or absence of the interaction in each of the XR stores, not setting information concerning how the interaction is carried out in each of the XR stores as described above.

For example, in a case where there is no setting information concerning the interaction, it is possible for the XR mall generating section 242 to provide, to the user, the XR mall which does not provide, with regard to the XR commodities, any explanation or support that is unnecessary for the user and in which a preference of the user is more reflected.

In a case where an XR salesclerk can be disposed in each of the XR stores, the setting information concerning the interaction in each of the XR stores may include setting information concerning the XR salesclerk. Typically, in the conventional EC site, there is no guide such as a salesclerk. In a case where the XR salesclerk is disposed in each of the XR stores, information that is not conveyed by a text can be supplementally explained by the XR salesclerk. Therefore, it is possible to provide, to the user, attendance of higher quality.

Examples of the setting information concerning the XR salesclerk include (i) setting information concerning the presence or absence of the XR salesclerk, (ii) setting information concerning explanation of a commodity by the XR salesclerk. (e.g., content and range of the explanation, and a communication level), and (iii) setting information concerning an appearance of the XR salesclerk. Examples of the setting information concerning the appearance of the XR salesclerk include (i) setting information based on 3D modeling data, (ii) setting information based on a real salesclerk, and (iii) setting information based on a silhouette.

In a case where the setting information concerning the XR salesclerk includes the information concerning the presence or absence of the XR salesclerk and, for example, there is no XR salesclerk, it is possible for the XR mall generating section 242 to provide, to the user, the XR mall which does not provide, with regard to the XR commodities, any explanation or support that is unnecessary for the user and in which a preference of the user is more reflected.

In a case where the setting information concerning the XR salesclerk includes the setting information concerning the explanation of the commodity by the XR salesclerk and, for example, in a case where the XR salesclerk is set so as to carefully explain the commodity, the XR salesclerk can carefully explain and recommend the commodity which the user desires, even in a case where the user's request is ambiguous. This makes it possible to recommend the commodity in the form that is more suitable for the user. Therefore, it is possible to provide, to the user, the XR mall that has a sense of security and more credibility.

For example, in a case where the VR technology of the XR technology is used, the XR salesclerk introduces a function of the commodity that has a sense of reality and operability. In a case where the AR technology of the XR technology is used, the XR salesclerk can recommend the commodity that has a size and a feeling of installation. As a result, it is possible to provide, to the user, the XR mall that is satisfactory.

In a case where the setting information concerning the XR salesclerk includes the setting information concerning the appearance of the XR salesclerk, it is possible to provide, to the user, the XR mall in which a preference of the user is reflected and which is more personalized.

### Setting Information Concerning Disposition of Each of XR Stores

The setting information concerning the disposition of each of the XR stores may include, for example, setting information concerning the disposition of each of the XR stores which disposition is desired by the user or setting information indicating that each of the XR stores is randomly disposed.

In a case where the setting information concerning the XR mall which setting information is set by the user includes the setting information concerning the disposition of each of the XR stores, it is possible for the XR mall generating section 242 to provide, to the user, the XR mall in which a preference of the user is more reflected.

### Setting Information Concerning Size of XR Mall

In a case where the setting information concerning the XR mall which setting information is set by the user includes the setting information concerning the size of the XR mall, it is possible for the XR mall generating section 242 to provide, to the user, the XR mall in which a preference of the user is more reflected.

### Setting Information Concerning Appearance of XR Mall

The setting information concerning the appearance of the XR mall may include at least one of information concerning an exterior of the mall and information concerning an interior of the mall.

In a case where the setting information concerning the XR mall which setting information is set by the user includes the setting information concerning the appearance of the XR mall, it is possible for the XR mall generating section 242 to provide, to the user, the XR mall in which a preference of the user is more reflected.

Next, the information concerning the XR stores is described with reference to FIG. 3. FIG. 3 is a view illustrating an example of a structure of the information concerning the XR stores.

### Information Concerning the XR Store

The information concerning the XR stores may be, for example, information concerning a commodity in a physical store that corresponds to at least one of the XR stores included in the XR mall, point cloud information concerning an inside of each of the stores, stock information, information concerning an appearance (such as an exterior and an interior) of each of the stores, and information concerning a salesclerk in the physical store. The information concerning the commodity in the physical store may be, for example, 3D modeling data of the commodity.

In a case where the information concerning the XR stores includes the information concerning the physical store that corresponds to at least one of the XR stores, it is possible for the XR mall generating section 242 to generate the at least one of the XR stores that is more realistic.

As illustrated in FIG. 3, the information concerning the XR stores may include store-side setting information.

### Store-Side Setting Information

The store-side setting information may include at least one of (i) store-side setting information concerning a condition under which each of the XR stores is opened in the XR mall, (ii) store-side setting information concerning disposition of each of the XR stores, (iii) store-side setting information concerning a commodity displayed in each of the XR stores, (iv) store-side setting information concerning an interaction in each of the XR stores, and (v) store-side setting information concerning a behavior of the XR salesclerk.

This makes it possible for both of a store side and the user who is a customer to set the XR mall. Therefore, it is possible for the XR mall generating section 242 to generate the XR mall that includes the XR stores, that is desired by both the store side and the user, and that uses the merits of the mall-type EC site and the in-house EC site and overcomes the demerits of the conventional EC site.

For example, it is possible to take advantage of the merits of the mall-type EC site, i.e., a power of attracting customers, credibility, and simplicity, and the merits of the in-house EC site, i.e., a benefit, branding, and a repeating rate. Furthermore, it is possible to overcome the demerits of the mall-type EC site, i.e., a charge, price competition, branding, and marketing, and the demerits, i.e., a power of attracting customers, results, and operation. Store-side setting information concerning condition under which each of XR stores is opened in XR mall

The store-side setting information concerning the condition under which each of the XR stores is opened in the XR mall may be, for example, information in which whether or not each of the XR stores is opened is set in accordance with the information concerning the user, such as the attribute information concerning the user.

This makes it possible for the XR mall generating section 242 to determine the XR stores included in the XR mall, from the XR store group that are the candidates for the XR stores included in the XR mall, with reference to not only the attribute information indicating a preference of the user but also the store-side setting information concerning the condition under which each of the XR stores is opened in the XR mall. As a result, it is possible for the XR mall generating section 242 to determine the XR stores each of which matches both the user's request and the store side's request, as the XR stores included in the XR mall.

For example, it is possible for the XR mall generating section 242 to include and open, in the XR mall, only the XR stores in each of which there is a possibility that the user purchases a commodity, among the XR store group that are the candidates for the XR stores included in the XR mall.

### Store-Side Setting Information Concerning Disposition of Each of XR Stores

The store-side setting information concerning the disposition of each of the XR stores may include, for example, setting information concerning the disposition of each of the XR stores which disposition varies depending on the other of the XR stores included in the XR mall. In a case where the store-side setting information includes the store-side setting information concerning the disposition of each of the XR stores, it is possible to generate the XR mall including the XR stores which the store side also desires.

For example, the setting information concerning the disposition of each of the XR stores which disposition varies depending on the other of the XR stores included in the XR mall may be information in which whether or not each of the XR stores is disposed near the other of the XR stores that is the other company in the same industry is set. With this information, for example, by disposing an XR store near another XR store of another famous company in the same industry, it is possible to cause the user to purchase a commodity also in the XR store near the another XR store at a time of purchase in the another XR store. Alternatively, by not disposing the XR store near the another XR store, it is possible to avoid competition with the another company in the same industry.

### Store-Side Setting Information Concerning Commodity Displayed in Each of XR Stores

The store-side setting information concerning the commodity displayed in each of the XR stores may be, for example, information in which the commodity displayed in each of the XR stores is set in accordance with the information concerning the user, such as the history information concerning the shopping that has been done by the user.

In a case where the store-side setting information includes the store-side setting information concerning the commodity displayed in each of the XR stores, it is possible to generate the XR mall including the XR stores in each of which the XR commodity desired by the user is displayed. As a result, it is possible to generate the XR mall including the XR stores each of which is desired by both the store side and the user who is a customer.

### Store-Side Setting Information Concerning Interaction in Each of XR Stores

The store-side setting information concerning the interaction in each of the XR stores may include, for example, store-side setting information concerning the interaction in each of the XR stores which interaction varies depending on a purchase tendency of a customer.

For example, the store-side setting information concerning the interaction in each of the XR stores may be information in which the purchase tendency of the customer and the interaction in each of the XR stores are associated with each other.

More specifically, in the store-side setting information concerning the interaction in each of the XR stores, a purchase tendency of a commodity-focusing customer may be associated with an interaction in which only information desired by the customer is accurately and quickly conveyed without propose of a different commodity in each of the XR stores. This is because what the customer demands is speed, the customer has a strong will for purchase, and what the store side aims at is to have the customer become a purchaser.

In the store-side setting information concerning the interaction in each of the XR stores, a purchase tendency of a visitor-type customer may be associated with an interaction in which a world view, a specialty, and the like of a commodity are explained while being compared with those of another commodity. This is because what the customer demands is a new discovery, the customer has a weak will for purchase, and what the store side aims at is to have the customer become at least one of a purchaser and an influencer.

In the store-side setting information concerning the interaction in each of the XR stores, a purchase tendency of a researcher-type customer may be associated with an interaction in which introduction and the like of relevant information and a commodity are carried out. This is because what the customer demands is collection of information, the customer has a weak will for purchase, and what the store side aims at is to have the customer become a purchaser.

In the store-side setting information concerning the interaction in each of the XR stores, a purchase tendency of a bargain-hunter-type customer may be associated with an interaction in which a discount rate and a price are clarified and a commodity is concentrated into a bargain corner. This is because what the customer demands is a privilege, the customer has a strong will for purchase, and what the store side aims at is to have the customer become a repeater.

In the store-side setting information concerning the interaction in each of the XR stores, a purchase tendency of a one-time shopper-type customer may be associated with an interaction in which a purchase process that does not require registration for a membership site of each of the XR stores is carried out and an easy shopping experience is provided to the customer. This is because what the customer demands are clarity and downsizing, the customer's will for purchase varies depending on a situation, and what the store side aims at is to provide a sense of security to the customer.

In this manner, in a case where the store-side setting information includes the store-side setting information concerning the interaction in each of the XR stores, it is possible to generate the XR mall including the XR stores that are more desired by both the store side and the user who is a customer, and provide the XR mall to the user. For example, in a case where the information concerning the user includes the setting information concerning the interaction in each of the XR stores, it is possible to provide, to the user, an interaction that is more desired by both the store side and the user, while matching an interaction desired by the store side and an interaction desired by the user.

### Store-Side Setting Information Concerning Behavior of XR Salesclerk

The store-side setting information concerning the behavior of the XR salesclerk may be, for example, information in which based on which one of artificial intelligence (AI) and a behavior of a performer the XR salesclerk behaves is set.

In this case, the store side may input, to the input section 320, the store-side setting information concerning the behavior of the XR salesclerk. This makes it possible for the XR mall generating section 242 to cause the XR salesclerk to behave as an AI salesclerk who automatically attends to a customer on the basis of the AI or as an avatar salesclerk who manually attends to the customer on the basis of a behavior of the performer on the store side, in accordance with the store-side setting information concerning the behavior of the XR salesclerk. Note that the performer may or may not be an operator himself/herself of the store-side terminal 300.

In this case, a predicting device that predicts the behavior of the XR salesclerk which behavior is based on the AI may be stored in the storage section 230. The predicting device may predict the behavior of the XR salesclerk with reference to a learning model, such as a neural network, that uses, as input data, training data in which a behavior of a customer and a behavior of a salesclerk in at least one of a physical store and an XR store are associated with each other.

With this configuration, in a case where the user who is a customer newly behaves, it is possible for the predicting device to predict the behavior of the XR salesclerk with reference to the learning model, and it is possible for the XR mall generating section 242X of the main control section 240 to cause the XR salesclerk to make the behavior predicted by the predicting device of the storage section 230.

The store side may set the store-side setting information concerning the behavior of the XR salesclerk in accordance with the user. For example, in a case where the user is a regular customer, the store side sets the store-side setting information concerning the behavior of the XR salesclerk so that the XR salesclerk behaves based on the AI. This makes it possible to reduce a burden on the performer. In a case where the user is not a regular customer, the store side sets the store-side setting information concerning the behavior of the XR salesclerk so that the XR salesclerk behaves based on the behavior of the performer. This makes it possible to attend to the user with more sense of security and credibility.

In this manner, in a case where the store-side setting information includes the store-side setting information concerning the behavior of the XR salesclerk, it is possible to generate the XR mall including the XR stores in each of which the interaction desired more by the store side is carried out. Further, in a case where the store-side setting information concerning the behavior of the XR salesclerk is set in accordance with the user, it is possible to generate the XR mall including the XR stores in each of which the interaction desired more by the user is carried out.

Note that the store side may spontaneously input, into the input section 320, the store-side setting information concerning the behavior of the XR salesclerk. Note also that, at a given timing, the main control section 240X may cause the communication section 210 to transmit, to the communication section 110 of the store-side terminal 300, attendance request information that encourages the store side to input the store-side setting information concerning the behavior of the XR salesclerk.

In a case where the attendance request information that encourages the store side to input the store-side setting information concerning the behavior of the XR salesclerk is transmitted to the communication section 110 of the store-side terminal 300, it is possible for the store side to suitably set, at a given timing, the store-side information concerning the behavior of the XR salesclerk, without voluntarily carrying out management.

Note that, in the example of FIG. 3, the store-side setting information concerning the interaction in each of the XR stores and the store-side setting information concerning the behavior of the XR salesclerk differ from each other. However, the store-side setting information concerning the interaction in each of the XR stores may include the store-side setting information concerning the behavior of the XR salesclerk.

The information concerning the XR stores may further include (i) real-time measurement information concerning a physical store corresponding to at least one of the XR stores included in the XR mall and (ii) setting information concerning a live commerce of at least one of the XR stores included in the XR mall.

The real-time measurement information concerning the physical store corresponding to at least one of the XR stores included in the XR mall may be, for example, information obtained by measuring, with a sensor or the like in real time, a commodity in the physical store, a stock status of the physical store, an appearance (such as an exterior and an interior) of the physical store, and a salesclerk in the physical store.

The store-side setting information concerning the live commerce of at least one of the XR stores may be, for example, information set with regard to a notification of an invitation to or an advertisement of the live commerce in which the store side carries out, in the at least one of the XR stores, a live explanation, a live sale, and the like of a commodity with respect to the user.

### Information Concerning XR Mall

The information concerning the XR mall, which information is generated by the XR mall generating section 242, may be data necessary to cause the user to experience the XR mall. The information concerning the XR mall may include, for example, the following information:
data indicating the XR stores included in the XR mall;
3D modeling data of the XR mall;
data of an environmental voice in the XR mall;
data of the disposition of each of the XR stores in the XR mall;
3D modeling data of each of the XR stores;
data of an environmental voice in each of the XR stores;
data indicating whether the XR salesclerk is disposed in each of the XR stores;
3D modeling data of each XR salesclerk;
data of voice of each XR salesclerk;
data indicating the commodity disposed in each of the XR stores;
3D modeling data of each commodity;
data of explanation of each commodity;
etc.

### XR Mall Providing Section 244

The XR mall providing section 244 may provide the XR mall to the user. This makes it possible to provide a realistic shopping experience to the user and reduce a time for the user to take to move to a physical store.

In a case where various pieces of information, such as the information concerning the user and the information concerning the XR stores, are received from the customer-side terminal 100 and the store-side terminal 300 after the XR mall is generated, the XR mall providing section 244 may update the XR mall with reference to the various pieces of information, and then provide the XR mall to the user.

### Example 1 of Provision of XR Mall

The XR mall providing section 244 may update at least one of the XR stores with reference to the real-time measurement information concerning the physical store, and provide, to the user, the at least one of the XR stores that has been updated.

In this case, after the XR mall is generated, the input section 320 of the store-side terminal 300 may accept, from the store side, an input of the real-time measurement information concerning the physical store. The main control section 240 of the XR mall generating device 200 may receive, from the communication section 110 of the store-side terminal 300, the real-time measurement information concerning the physical store, via the communication section 210.

The XR mall providing section 244 in the main control section 240 may update the at least one of the XR stores in the XR mall, with reference to the real-time measurement information concerning the physical store. The XR mall providing section 244 may cause the communication section 210 to transmit, to the communication section 110 of the customer-side terminal 100, the information concerning the XR mall including the at least one of the XR stores with regard to which the real-time measurement information concerning the physical store has been referred to. The XR mall providing section 244 may thus provide, to the user, the XR mall including the at least one of the XR stores.

In this manner, in a case where the XR mall providing section 244 provides, to the user, the at least one of the XR stores with reference to the real-time measurement information concerning the physical store, it is possible to provide, to the user, the XR mall including the at least one of the XR stores in which a real-time situation of the physical store is reflected and which is more realistic.

### Example 2 of Provision of XR Mall

The XR mall providing section 244 may provide, to the user, the live commerce of at least one of the XR stores included in the XR mall, with reference to the setting information concerning the live commerce of the at least one of the XR stores.

This makes it possible for the store side to advertise the at least one of the XR stores, such as explanation and sale of a commodity of the at least one of the XR stores, and makes it possible for the user to obtain information concerning the commodity of the at least one of the XR stores or purchase the commodity on the spot. As a result, it is possible to provide the XR mall including the XR stores each of which is more desired by both the store side and the user who is a customer.

In this case, after the XR mall is generated, the input section 320 of the store-side terminal 300 may accept, from the store side, an input of the setting information concerning the live commerce of the at least one of the XR stores. The main control section 240 of the XR mall generating device 200 may receive, from the communication section 110 of the store-side terminal 300, the setting information concerning the live commerce of the at least one of the XR stores, via the communication section 210.

The XR mall providing section 244 in the main control section 240 may cause the communication section 210 to transmit the setting information concerning the live commerce of the at least one of the XR stores to the communication section 110 of the customer-side terminal 100.

Note that, in a case where it is possible for the store side to directly notify the user, who is a customer, of an advertisement of or an invitation to the live commerce, the XR mall providing section 244 may not transmit, to the customer-side terminal 100, the setting information concerning the live commerce. The case where it is possible for the store side to directly notify the user of the advertisement of or the invitation to the live commerce is, for example, a case where, in the past, the user visited the at least one of the XR stores or a physical store corresponding to the at least one of the XR stores and registered for at least one of a mail and an SNS.

The XR mall providing section 244 may carry out the live commerce in which a live invitation to and live sale of the commodity are carried out, with respect to a customer who has come to the at least one of the XR stores on the day on which the live commerce is held, among customers who have been notified of the advertisement of or the invitation to the live commerce.

In a case where another user than a participant who has visited the XR mall approaches the at least one of the XR stores, the XR mall providing section 244 may provide the live commerce also to the another user in accordance with the setting information concerning the live commerce of the at least one of the XR stores.

For example, in a case where the setting information concerning the live commerce of the at least one of the XR stores is set so that the live commerce is provided also to another user than a participant when the another user approaches the at least one of the XR stores, the XR mall providing section 244 may provide the live commerce to the another user. This makes it possible to more suitably advertise the commodity of the at least one of the XR stores to a customer.

### Example 3 of Provision of XR Mall

In a case where the input section 120 of the store-side terminal 300 accepts, from the store side, an input of new information concerning marketing, the XR mall providing section 244 may update the XR mall with reference to the information, and provide the XR mall to the user. This makes it possible for the XR mall providing section 244 to provide, to the user, the XR mall in which the new information concerning the marketing is reflected.

### Control Process Carried Out in XR Mall Generation System 1

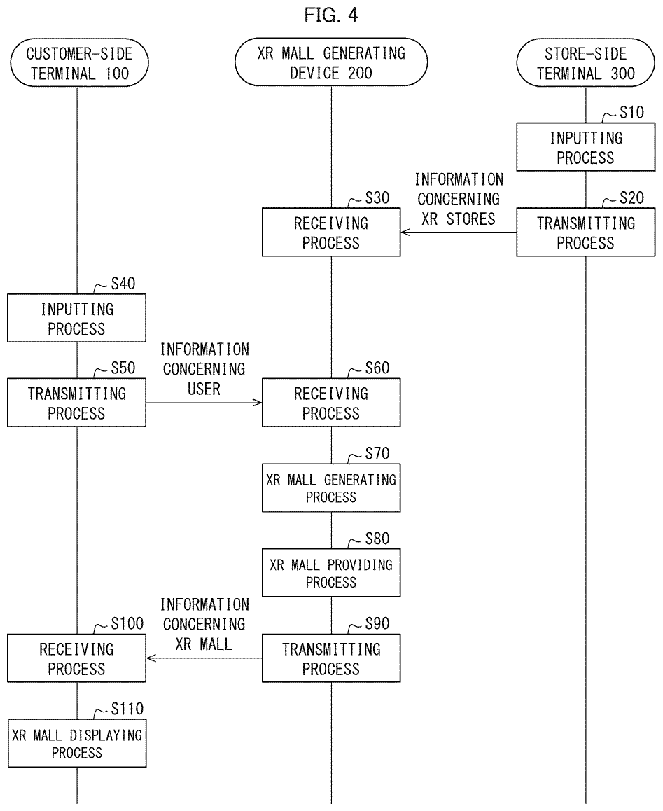

Next, a controlling process carried out in the XR mall generation system 1 (a method for controlling the XR mall generating device 200) in accordance with Embodiment 1 is described with reference to FIG. 4. FIG. 4 is a flowchart illustrating an example of the controlling process carried out in the XR mall generation system 1 in accordance with Embodiment 1.

### Step S10

The input section 320 of the store-side terminal 300 in the XR mall generation system 1 may carry out an inputting process of accepting, from the store side, an input of the information concerning the XR stores in the XR store group that are the candidates for the XR stores included in the XR mall (inputting step).

### Step S20

The main control section 150 of the store-side terminal 300 may cause the communication section 110 to carry out a transmitting process of transmitting the information concerning the XR stores to the communication section 210 of the XR mall generating device 200 in the XR mall generation system 1X (transmitting step).

That is, the communication section 110 of the store-side terminal 300 may carry out the transmitting process of transmitting the information concerning the XR stores to the communication section 210 of the XR mall generating device 200.

### Step S30

The communication section 210 of the XR mall generating device 200 may carry out a receiving process of receiving the information concerning the XR stores from the communication section 110 of the store-side terminal 300 (receiving step).

### Step S40

The input section 120 of the customer-side terminal 100 in the XR mall generation system 1 may carry out an inputting process of accepting, from the user, an input of the information concerning the user (inputting step).

### Step S50

The main control section 150 of the customer-side terminal 100 in the XR mall generation system 1 may cause the communication section 110 to carry out a transmitting process of transmitting the information concerning the user to the communication section 210 of the XR mall generating device 200 in the XR mall generation system 1 (transmitting step).

That is, the communication section 110 of the customer-side terminal 100 may carry out the transmitting process of transmitting the information concerning the user to the communication section 210 of the XR mall generating device 200.

### Step S60

The communication section 210 of the XR mall generating device 200 may carry out a receiving process of receiving the information concerning the user from the communication section 110 of the customer-side terminal 100 (receiving step).

### Step S70

The XR mall generating section 242 in the main control section 240 of the XR mall generating device 200 may carry out an XR mall generating process of generating the XR mall with reference to the information concerning the user, the information concerning the XR stores, and the like (XR mall generating step).

The XR mall generating step is described below in detail. In an aspect, the XR mall generating section 242 may determine the XR store group that are the candidates for the XR stores included in the XR mall, with reference to the attribute information concerning the user, which attribute information indicates at least one of the color preference, the hobby preference, the commodity preference, and the brand preference of the user, in the information concerning the user. The XR mall generating section 242 may determine, from the XR store group, the XR stores included in the XR mall, in accordance with information concerning a user attribute and with reference to, among the information concerning the XR stores, the store-side setting information concerning the condition under which each of the XR stores is opened in the XR mall, in which store-side setting information whether or not each of the XR stores is opened is set.

This makes it possible for the XR mall generating section 242 to determine the XR stores each of which matches both the user's request and the store side's request, as the XR stores included in the XR mall.

In an aspect, the XR mall generating section 242 may determine candidates for the commodity displayed in each of the XR stores, with reference to the history information concerning the shopping in at least one of the physical store, the EC site, and the XR mall (e.g., the history information concerning the movement in the XR mall) in the information concerning the user. The XR mall generating section 242 may determine the commodity displayed in each of the XR stores, with further reference to the store-side setting information concerning the commodity displayed in each of the XR stores in the information concerning the XR stores.

In this case, it is possible for the XR mall generating section 242 to match the history information concerning the shopping that has been done by the user and the store-side setting information concerning the commodity displayed in each of the XR stores, and generate the XR mall including the XR stores in each of which the XR commodity desired by the user is displayed. As a result, it is possible to generate the XR mall including the XR stores each of which is desired by both the store side and the user who is a customer.

In an aspect, the XR mall generating section 242 may determine the interaction in each of the XR stores, with reference to the setting information concerning the interaction in each of the XR stores, among the information concerning the user. The XR mall generating section 242 may determine the interaction in each of the XR stores, with further reference to the store-side setting information concerning the interaction in each of the XR stores, among the information concerning the XR stores.

This makes it possible for the XR mall generating section 242 to match the setting information concerning the interaction in each of the XR stores which setting information is set by the user and the store-side setting information concerning the interaction in each of the XR stores, and determine the interaction which is carried out in each of the XR stores and which is desired by both the user and the store side.

For example, the XR mall generating section 242 may determine the presence or absence of the XR salesclerk, explanation of the commodity by the XR salesclerk, and the appearance of the XR salesclerk, with reference to the setting information concerning the XR salesclerk in the setting information concerning the interaction in each of the XR stores which setting information is set by the user. The XR mall generating section 242 may determine which one of the AI and the behavior of the performer the XR salesclerk behaves based on, with further reference to the store-side setting information concerning the behavior of the XR salesclerk in the store-side setting information concerning the interaction in each of the XR stores. This makes it possible for the XR mall generating section 242 to generate the XR stores in each of which the XR salesclerk desired by both the user and the store side is disposed.

In an aspect, the XR mall generating section 242 may determine candidates for the disposition of each of the XR stores, with reference to the setting information concerning the disposition of each of the XR stores or the setting information concerning the disposition of each of the XR stores in which disposition each of the XR stores is randomly disposed, among the information concerning the user. The XR mall generating section 242 may determine the disposition of each of the XR stores from the candidates for the disposition of each of the XR stores, with further reference to the setting information concerning the disposition of each of the XR stores which disposition varies depending on the other of the XR stores included in the XR mall, among the information concerning the XR stores.

In this case, it is possible for the XR mall generating section 242 to match the setting information concerning the disposition of each of the XR stores and the setting information concerning the disposition of each of the XR stores which disposition varies depending on the other of the XR stores included in the XR mall, and determine the disposition of each of the XR stores which disposition is desired by both the user and the store side. For example, it is possible to determine the disposition of each of the XR stores so that each of the XR stores is disposed near or far from the other of the XR stores, among the candidates for the disposition of each of the XR stores which disposition is desired by the user.

In an aspect, the XR mall generating section 242 may generate the XR mall of a size desired by the user, with reference to the setting information concerning the size of the XR mall, among the information concerning the user.

In an aspect, the XR mall generating section 242 may generate the XR mall that has the appearance, such as the exterior and the interior, in which the preference of the user is reflected, with reference to at least one of the setting information concerning the appearance of the XR mall, among the information concerning the user.

In an aspect, the XR mall generating section 242 may generate the XR mall by integrating, as the information concerning the XR mall, the pieces of information determined by the above method.

### Step S80

The XR mall providing section 244 in the main control section 240 of the XR mall generating device 200 may carry out an XR mall providing process of providing the XR mall to the user (XR mall providing step).

For example, the XR mall providing section 244 may obtain, as the information concerning the XR mall for providing to the user, the XR mall generated by the XR mall generating section 242, and cause the communication section 210 to transmit the information concerning the XR mall.

### Step S90

The communication section 210 may transmit the information concerning the XR mall to the communication section 110 of the customer-side terminal 100.

### Step S100

The communication section 110 of the customer-side terminal 100 may carry out a receiving process of receiving the information concerning the XR mall from the communication section 210 of the XR mall generating device 200 (receiving step).

### Step S110

The main control section 150 of the customer-side terminal 100 may cause the display section 160 of the customer-side terminal 100 to carry out a displaying process of displaying the XR mall with reference to the information concerning the XR mall (displaying step). That is, the display section 160 may carry out the displaying process of displaying the XR mall.

### Embodiment 2

The XR mall generation system in accordance with an embodiment of the present invention may further provide the XR mall of the user to another user such as a friend of the user, as in an XR mall generation system 1X in accordance with Embodiment 2.

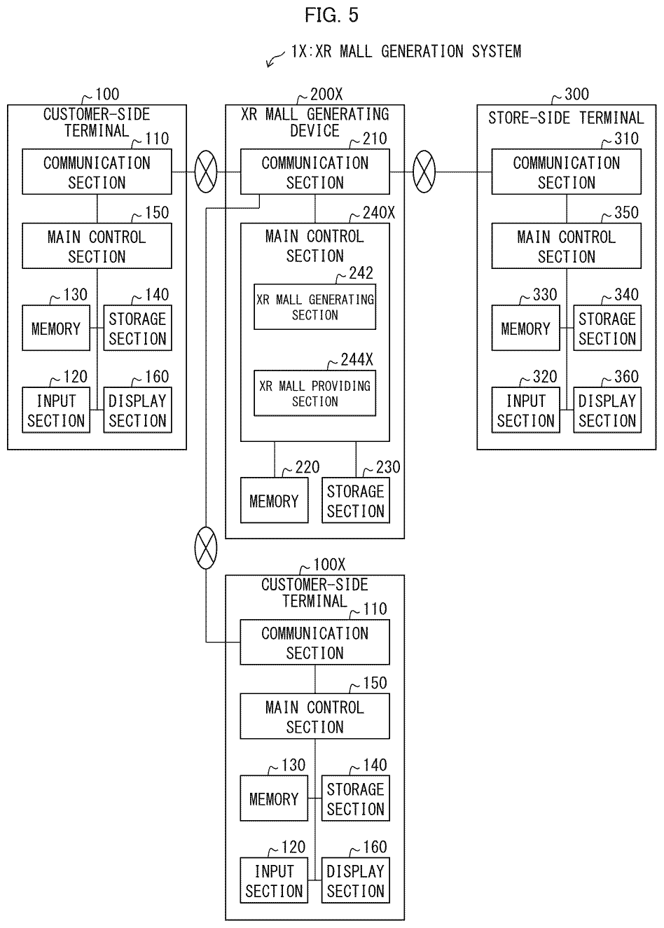

The XR mall generation system 1X in accordance with Embodiment 2 is described below with reference to FIG. 5. Note that, for convenience, members having the same functions as those of the members described in the above embodiment are given the same reference signs and description thereof is omitted.

### XR Mall Generation System 1X

As illustrated in FIG. 5, the XR mall generation system 1X may further include a customer-side terminal 100X of another user. The XR mall generation system 1X may include an XR mall generating device 200X instead of the XR mall generating device 200 in accordance with Embodiment 1. Otherwise, the XR mall generation system 1X may have a configuration similar to that of the XR mall generation system 1 in accordance with Embodiment 1.

### XR Mall Generating Device 200X

As illustrated in FIG. 5, the XR mall generating device 200X may include a main control section 240X, instead of the main control section 240 in Embodiment 1. Otherwise, the XR mall generating device 200X may have a configuration similar to that of the XR mall generating device 200 in accordance with Embodiment 1.

### Main Control Section 240X

As illustrated in FIG. 5, the main control section 240X may include an XR mall providing section 244X, instead of the XR mall providing section 244 in Embodiment 1. Otherwise, the main control section 240X may have a configuration similar to that of the main control section 240 in Embodiment 1.

### XR Mall Providing Section 244X

The XR mall providing section 244X may provide an XR mall further to another user, and invite the another user to the XR mall. In this case, after the XR mall is generated, the XR mall providing section 244X may cause information concerning the XR mall of a user to be transmitted via a communication section 210, and provide the XR mall to the another user.

This makes it possible for the another user to participate in the XR mall of the user, and makes it possible for the user to share a shopping experience with the another user in the XR mall and communicate with the another user.

By, for example, a mail or an SNS, the user may notify the another user of an invitation to the XR mall, the another user may agree, and, after the XR mall is generated, the user may notify the another user of opening of the XR mall. Alternatively, the user may notify the another user via the XR mall providing section 244X.

For example, in a case where an input section 120 of a customer-side terminal 100 accepts, from the user, an input of information concerning a notification such as a notification of an invitation to the XR mall and a notification of opening of the XR mall, the XR mall providing section 244X may obtain the information via a communication section 110 and the communication section 210, and transmit the information to the customer-side terminal 100X. This also makes it possible to suitably notify the another user of the XR mall.

In a case where the XR mall providing section 244X has provided the XR mall to the another user, the XR mall providing section 244X may notify the user that the XR mall has been provided to the another user and the another user has participated in the XR mall. This makes it easier for the user to meet the another user in the XR mall, share a shopping experience more with the another user, and communicate with the another user.

Note that, in the above example, the XR mall providing section 244X provides the XR mall to one other user. The XR mall providing section 244X may provide the XR mall to two or more other users.

### Hardware Configuration and Software Implementation Example

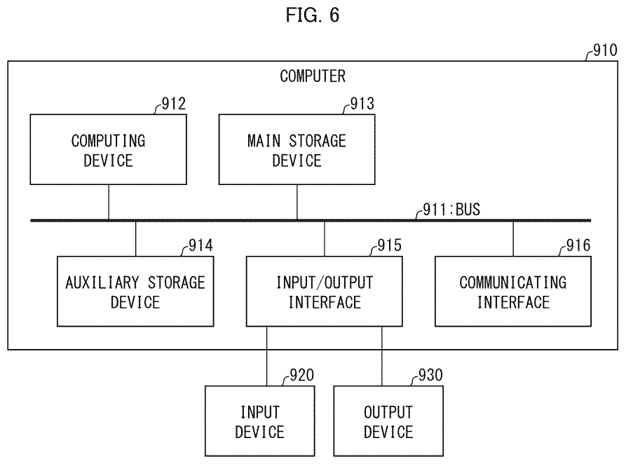

Control blocks of the customer-side terminals 100 and 100X, the XR mall generating devices 200 and 200X, and the store-side terminal 300 (particularly, each section included in the main control section 150, the XR mall generating section 242 included in each of the main control sections 240 and 240X, and the XR mall providing sections 244 and 244X included in the main control sections 240 and 240X, respectively, etc.) may be realized by a logic circuit (hardware) provided to an integrated circuit (IC chip) or the like or may be alternatively realized by software with use of a central processing unit (CPU). In the latter case, the customer-side terminals 100 and 100X, the XR mall generating devices 200 and 200X, and the store-side terminal 300 may be configured with use of a computer (electronic calculator) as illustrated in FIG. 6.

FIG. 6 is a block diagram illustrating an example of a configuration of a computer 910 that can be used as each of the customer-side terminals 100 and 100X, the XR mall generating devices 200 and 200X, and the store-side terminal 300. The computer 910 may include a computing device 912, a main storage device 913, an auxiliary storage device 914, and an input/output interface 915 that are connected to each other via a bus 911. The computing device 912, the main storage device 913, and the auxiliary storage device 914 may be each, for example, a CPU, a random access memory (RAM), a solid-state drive, or a hard disk drive. To the input/output interface 915, an input device 920 via which the user inputs various pieces of information into the computer 910 and an output device 930 via which the computer 910 outputs various pieces of information to the user are connected. The input device 920 and the output device 930 may be embedded in the computer 910 or may be alternatively connected (externally provided) to the computer 910. For example, the input device 920 may be a button, a keyboard, a mouse, a touch sensor, or the like, and the output device 930 may be a lamp, a display, a printer, a speaker, or the like. Alternatively, a device that has functions of both of the input device 920 and the output device 930, such as a touch panel in which a touch sensor and a display are integrated, may be applied. A communicating interface 916 is an interface via which the computer 910 communicates with an external device.

In the auxiliary storage device 914, the XR mall generating program for causing the computer 910 to operate as the customer-side terminal 100 or 100X, the XR mall generating device 200 or 200X, or the store-side terminal 300 is stored. The computing device 912 may cause the computer 910 to function as each section included in the customer-side terminal 100 or 100X, the XR mall generating device 200 or 200X, or the store-side terminal 300, by loading, on the main storage device 913, the XR mall generating program stored in the auxiliary storage device 914 and executing a command included in the XR mall generating program. Note that a recording medium used by the auxiliary storage device 914 to record information such as the XR mall generating program only needs to be a computer-readable “non-transitory tangible medium”, and may be, for example, a tape, a disk, a card, a semiconductor memory, a programmable logic circuit, or the like.

Further, a configuration may be employed in which the computer 910 is caused to function with use of the XR mall generating program recorded in a recording medium outside the computer 910 or the XR mall generating program supplied to the computer 910 via any transmission medium (e.g., a communication network or a broadcast wave). An embodiment of the present invention can also be achieved in the form of a computer data signal in which the XR mall generating program is embodied via electronic transmission and which is embedded in a carrier wave.

A part or all of the functions of the control blocks can also be realized by a logic circuit. For example, the present invention also encompasses, in its scope, an integrated circuit to which the logic circuit that functions as each of the control blocks is provided. Alternatively, each of the functions of the control blocks can also be realized by, for example, a quantum computer.

Moreover, each process described in each embodiment may be carried out by AI. In this case, the AI may be operated by the main control section or may be operated by another device (e.g., an edge computer or a cloud server).

### Supplementary Note

A part of the invention disclosed in this specification can also be expressed as in the following aspects, but the invention is not limited to the following aspects.

An XR mall generating device in accordance with an aspect of the present invention is an XR mall generating device including: an XR mall generating section that generates an XR mall including a plurality of XR stores in each of which a user is capable of experiencing shopping with use of an XR technology; and an XR mall providing section that provides the XR mall to the user.

The XR mall generating device in accordance with an aspect of the present invention may be configured such that the XR mall generating section generates the XR mall for each user, with reference to information concerning the user.

The XR mall generating device in accordance with an aspect of the present invention may be configured such that the information concerning the user includes at least one of attribute information concerning the user, history information concerning shopping that has been done by the user, and setting information concerning the XR mall which setting information is set by the user.

The XR mall generating device in accordance with an aspect of the present invention may be configured such that the information concerning the user includes the attribute information concerning the user, and the attribute information concerning the user includes information indicating at least one of a color preference, a hobby preference, a commodity preference, and a brand preference of the user.

The XR mall generating device in accordance with an aspect of the present invention may be configured such that the information concerning the user includes the history information concerning the shopping that has been done by the user, and the history information concerning the shopping that has been done by the user includes history information concerning the shopping in at least one of a physical store, an EC site, and the XR mall.

The XR mall generating device in accordance with an aspect of the present invention may be configured such that the history information concerning the shopping that has been done by the user includes history information concerning the shopping in the XR mall, and the history information concerning the shopping in the XR mall includes history information concerning movement in the XR mall.

The XR mall generating device in accordance with an aspect of the present invention may be configured such that the information concerning the user includes the setting information concerning the XR mall which setting information is set by the user, and the setting information concerning the XR mall which setting information is set by the user includes at least one of setting information concerning an interaction in each of the plurality of XR stores, setting information concerning disposition of each of the plurality of XR stores, setting information concerning a size of the XR mall, and setting information concerning an appearance of the XR mall.

The XR mall generating device in accordance with an aspect of the present invention may be configured such that an XR salesclerk is capable of being disposed in each of the plurality of XR stores, the setting information concerning the XR mall which setting information is set by the user includes the setting information concerning the interaction in each of the plurality of XR stores, and the setting information concerning the interaction in each of the plurality of XR stores includes setting information concerning the XR salesclerk.

The XR mall generating device in accordance with an aspect of the present invention may be configured such that the XR mall generating section generates the XR mall with further reference to information concerning XR stores in an XR store group that are candidates for the plurality of XR stores included in the XR mall.

The XR mall generating device in accordance with an aspect of the present invention may be configured such that an XR salesclerk is capable of being disposed in each of the plurality of XR stores, and the information concerning the XR stores includes at least one of store-side setting information concerning a condition under which each of the XR stores is opened in the XR mall, store-side setting information concerning disposition of each of the XR stores, store-side setting information concerning a commodity displayed in each of the XR stores, store-side setting information concerning an interaction in each of the XR stores, and store-side setting information concerning a behavior of the XR salesclerk.

The XR mall generating device in accordance with an aspect of the present invention may be configured such that the information concerning the XR stores includes the store-side setting information concerning the behavior of the XR salesclerk, and the XR salesclerk behaves based on artificial intelligence (AI) or a behavior of a performer, in accordance with the store-side setting information concerning the behavior of the XR salesclerk.

The XR mall generating device in accordance with an aspect of the present invention may be configured such that the information concerning the XR stores includes the store-side setting information concerning the disposition of each of the XR stores, and the store-side setting information concerning the disposition of each of the XR stores includes setting information concerning the disposition of each of the XR stores which disposition varies depending on the other of the plurality of XR stores included in the XR mall.

The XR mall generating device in accordance with an aspect of the present invention may be configured such that the XR mall providing section provides, to the user, at least one of the plurality of XR stores included in the XR mall, with reference to real-time measurement information concerning a physical store corresponding to the at least one of the plurality of XR stores.

The XR mall generating device in accordance with an aspect of the present invention may be configured such that the XR mall providing section provides a live commerce of at least one of the plurality of XR stores with reference to setting information concerning the live commerce of the at least one of the plurality of XR stores.

The XR mall generating device in accordance with an aspect of the present invention may be configured such that the XR mall providing section further provides the XR mall to another user.

The XR mall generating device in accordance with an aspect of the present invention may be configured such that the XR technology includes at least one of virtual reality (VR), augmented reality (AR), mixed reality (MR), and substitutional reality (SR).

A method for controlling an XR mall generating device in accordance with an aspect of the present invention is a method for controlling an XR mall generating device, including: an XR mall generating step in which the XR mall generating device generates an XR mall including a plurality of XR stores in each of which a user is capable of experiencing shopping with use of an XR technology; and an XR mall providing step in which the XR mall generating device provides the XR mall to the user.

The XR mall generating device in accordance with each aspect of the present invention may be realized by a computer. In this case, the present invention also encompasses, in its scope, (i) an XR mall generating program for realizing the XR mall generating device by the computer by causing the computer to operate as each section (software element) included in the XR mall generating device and (ii) a computer-readable recording medium in which the XR mall generating program is recorded.

The present invention is not limited to the foregoing embodiments, but may be altered in various ways by a skilled person within the scope of the claims. The present invention also encompasses, in its technical scope, any embodiment derived by appropriately combining technical means disclosed in differing embodiments.

### REFERENCE SIGNS LIST

1, 1X XR mall generation system
100, 100X Customer-side terminal
200, 200X XR mall generating device
242 XR mall generating section
244, 244X XR mall providing section
300 Store-side terminal

1. An extended reality (XR) mall generating device comprising:
an XR mall generating section that generates an XR mall including a plurality of XR stores in each of which a user is capable of experiencing shopping with use of an XR technology; and
an XR mall providing section that provides the XR mall to the user, wherein
an XR salesclerk is capable of being disposed in each of the plurality of XR stores,
the XR mall generating section generates the XR salesclerk disposed in each of the plurality of XR stores, with reference to setting information concerning the XR salesclerk which setting information is set by the user and store-side setting information concerning a behavior of the XR salesclerk which store-side setting information is set by a store side of each of the plurality of XR stores,
the setting information concerning the XR salesclerk which setting information is set by the user, regardless of the store-side setting information concerning the behavior of the XR salesclerk, and
based on which one of artificial intelligence (AI) and a behavior of a performer the XR salesclerk behaves is determined in accordance with the store-side setting information concerning the behavior of the XR salesclerk.

2. The XR mall generating device of claim 1, wherein the XR mall generating section generates the XR mall for each user, with reference to information concerning the user.

3. The XR mall generating device of claim 2, wherein
the information concerning the user includes at least one of
attribute information concerning the user,
history information concerning shopping that has been done by the user, and
setting information concerning the XR mall which setting information is set by the user.

4. The XR mall generating device of claim 3, wherein
the information concerning the user includes the attribute information concerning the user, and
the attribute information concerning the user includes information indicating at least one of a color preference, a hobby preference, a commodity preference, and a brand preference of the user.

5. The XR mall generating device of claim 3, wherein
the information concerning the user includes the history information concerning the shopping that has been done by the user, and
the history information concerning the shopping that has been done by the user includes history information concerning the shopping in at least one of a physical store, an EC site, and the XR mall.

6. The XR mall generating device of claim 5, wherein
the history information concerning the shopping that has been done by the user includes history information concerning the shopping in the XR mall, and
the history information concerning the shopping in the XR mall includes history information concerning movement in the XR mall.

7. The XR mall generating device of claim 3, wherein
the information concerning the user includes the setting information concerning the XR mall which setting information is set by the user, and
the setting information concerning the XR mall which setting information is set by the user includes at least one of
setting information concerning an interaction in each of the plurality of XR stores,
setting information concerning disposition of each of the plurality of XR stores,
setting information concerning a size of the XR mall, and
setting information concerning an appearance of the XR mall.

8. (canceled)

9. The XR mall generating device of claim 2, wherein the XR mall generating section generates the XR mall with further reference to information concerning XR stores in an XR store group that are candidates for the plurality of XR stores included in the XR mall.

10. The XR mall generating device of claim 9, wherein
the information concerning the XR stores includes at least one of
store-side setting information concerning a condition under which each of the XR stores is opened in the XR mall,
store-side setting information concerning disposition of each of the XR stores,
store-side setting information concerning a commodity displayed in each of the XR stores, and
store-side setting information concerning an interaction in each of the XR stores.

11. (canceled)

12. The XR mall generating device of claim 10, wherein
the information concerning the XR stores includes the store-side setting information concerning the disposition of each of the XR stores, and
the store-side setting information concerning the disposition of each of the XR stores includes setting information concerning the disposition of each of the XR stores which disposition varies depending on the other of the plurality of XR stores included in the XR mall.

13. The XR mall generating device of claim 9, wherein the XR mall providing section provides, to the user, at least one of the plurality of XR stores included in the XR mall, with reference to real-time measurement information concerning a physical store corresponding to the at least one of the plurality of XR stores.

14. The XR mall generating device of claim 9, wherein the XR mall providing section provides a live commerce of at least one of the plurality of XR stores with reference to setting information concerning the live commerce of the at least one of the plurality of XR stores.

15. The XR mall generating device of claim 1, wherein the XR mall providing section further provides the XR mall to another user.

16. The XR mall generating device of claim 1, wherein
the XR technology includes at least one of
virtual reality (VR),
augmented reality (AR),
mixed reality (MR), and
substitutional reality (SR).

17. A method for controlling an extended reality (XR) mall generating device, comprising:
an XR mall generating step in which the XR mall generating device generates an XR mall including a plurality of XR stores in each of which a user is capable of experiencing shopping with use of an XR technology; and
an XR mall providing step in which the XR mall generating device provides the XR mall to the user, wherein
an XR salesclerk is capable of being disposed in each of the plurality of XR stores,
in the XR mall generating step, the XR mall generating device generates the XR salesclerk disposed in each of the plurality of XR stores, with reference to setting information concerning the XR salesclerk which setting information is set by the user and store-side setting information concerning a behavior of the XR salesclerk which store-side setting information is set by a store side of each of the plurality of XR stores,
the setting information concerning the XR salesclerk which setting information is set by the user, regardless of the store-side setting information concerning the behavior of the XR salesclerk, and
based on which one of artificial intelligence (AI) and a behavior of a performer the XR salesclerk behaves is determined in accordance with the store-side setting information concerning the behavior of the XR salesclerk.

18. An XR mall generating program for causing a computer to function as the XR mall generating device of claim 1, the XR mall generating program causing the computer to function as the XR mall generating section and the XR mall providing section.
